(19) United States
(12) Patent Application Publication
(10) Pub. No.: US 2024/0169408 A1
(43) Pub. Date: May 23, 2024

(54) FUTURE PRODUCT RELEASE PLATFORM

(71) Applicant: eBay Inc., San Jose, CA (US)

(72) Inventors: Gilad Eliyahu Fuchs, Kfar-Saba (IL); Ido Ben-Shaul, Ramat Hasharon (IL); Matan Mandelbrod, Pardes Hanna Karkur (IL)

(21) Appl. No.: 17/991,175

(22) Filed: Nov. 21, 2022

(51) Int. Cl. G06Q 30/06; G06F 40/295; G06Q 30/02

(52) U.S. Cl. CPC G06Q 30/0627; G06F 40/295; G06Q 30/0202

(57) ABSTRACT

A method of predicting a release date of an item is provided. The method includes applying a first rule set to a first data set to create a second data set. The first rule set includes a rule that correlates a phrase with a date within a text string of the first data set. A second rule set is then applied to the second data set to create a third data set. The second rule set can include a rule that identifies a first item within a text string of the second data set and correlates the first item with the date such that the third data set has the first item that correlates with the date. A release date is then identified for the first item based on the date and a language pattern associated with the date.

### TECHNICAL FIELD

Examples of the present disclosure relate generally to data recognition and, more particularly, but not by way of limitation, to using machine learning to determine a release date based on language patterns.

### BACKGROUND

When a new product is released, there can be a great amount of interest relating to the new product. The interest can include information about the product, such as performance, styling, price, etc. Moreover, the interest can include inquiries about obtaining the product, such as who sells the new product and what is the wait time for the new product. In order to be prepared to provide responses to the queries, an entity, such as a selling entity, should have an idea of when the new product will be released. Thus, the selling entity can make preparations to handle inquiry demands that can occur when the new product is released. Preparation can include creating marketing materials for the new product and information pages that discuss the new product, such as performance, styling, price, etc. However, if the selling entity is unaware of when a new product is released, or what the demand will be when the new product is released, the selling entity will be ill-equipped to respond to inquiries upon the new product release.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment 100 suitable for determining a release date for a product/work of art, according to some examples.

FIG. 2 is a block diagram of an item release platform of FIG. 1 that provides functionality to determine a release date for a product/work, according to some examples.

FIG. 3 illustrates a method that predicts a release date for a product/work of art, according to some examples.

FIG. 4 illustrates a method that predicts a release date for a product/work of art, according to some examples.

FIG. 5 is a graphic that correlates a release date of a product/work of art to a number of queries, according to some examples.

FIG. 6 is a block diagram illustrating architecture of software used to implement social network initiated listings, according to some examples.

FIG. 7 shows a machine as an example computer system with instructions to cause the machine to implement social network initiated listings, according to some examples.

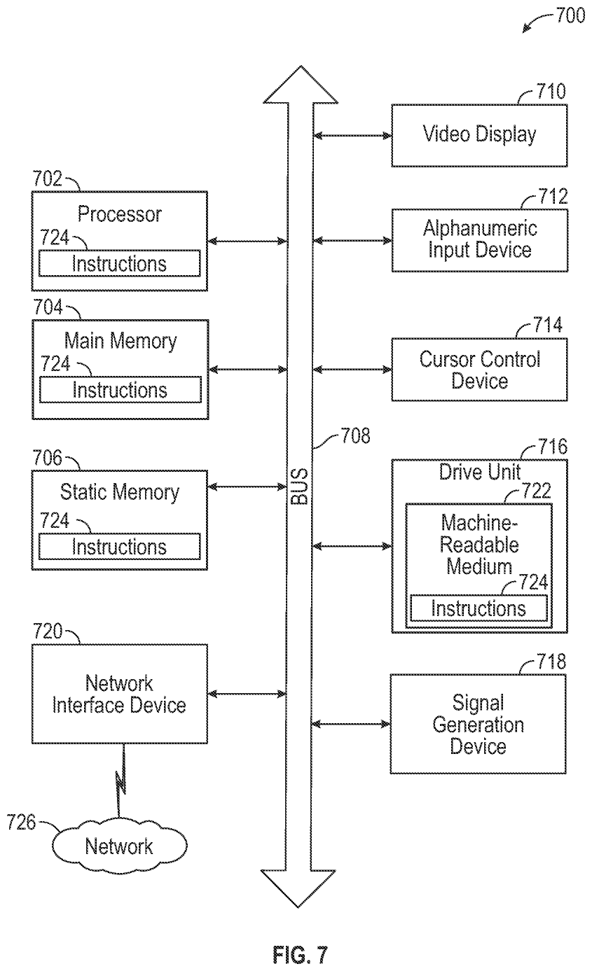

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Examples relate to a method and system for training a machine learning model to determine when a product will be released. An item release platform can pull webpages from different websites and apply rules to the web pages to predict when a product will be released. The item release platform can perform a first rule filtering where webpages that discuss products or works of arts, such as an electronic device or a book, are found and webpages that do not mention a product/work of art are filtered. A named entity extraction (NER) procedure is then performed on the filtered web pages to determine which of the webpages discuss a product/work of art and have a date associated with the product/work of art. A text to release procedure is then performed on the webpages having a product/work of art and a date to filter out those webpages that do not discuss a release date of a product/work of art. For those webpages remaining that include a product/work of art and a release date, the release dates associated with each product/work of art are aggregated and, based on the aggregated release dates, a release date is predicted.

To further illustrate, an item release platform can obtain webpages from various websites and clean the webpages. Cleaning can include removing non-natural language text and offensive language from the webpages. The item release platform can apply a first rule set to the first data set to create a second data set. The first rule set can include filtering the webpages in the first data set using various phrases, such as the phrase “will be released.” Those webpages that are found to include the phrase “will be released” can be filtered from the first data set to create the second data set. A second rule set can then be applied to the second data set to create a third data set. The second rule set can further filter the second data set by searching for web pages in the second data set that include products/works of art along with various dates. Those web sites that include products/works of art along with dates associated with the products/works of art are filtered to create the third data set.

Once the third data set is created using the second rule set, a classifier can be applied to the third data set to make a connection between the products/works of art and the dates. In particular, the classifier can predict which data sets of the third data sets have text strings relating to a release date of a product/work of art and those data sets of the third data set that do not. The data sets that are deemed to not have text strings relating to a release date of products/works of art are filtered out. After the classifier determines which data sets have text strings pertaining to a future release date of a product/work of art, the release dates of the product/work of art are aggregated. Based on the aggregated dates, a release date of the product can be predicted.

In further examples, a first rule set is applied to a first data set having text strings gathered from various local and remote data sources to create a second data set. The first rule set can include a rule that correlates a phrase with a date within a text string of the first data set. A second rule set can then be applied to the second data set to create a third data set. The second rule set can include a rule that identifies a first item within the text string of the second data set and correlate the first item with the date. Using the date and a language pattern associated with the date, a release date for the first item can be determined. In examples, a machine learning model can be trained with the identified release date and the language pattern associated with the date and used to identify future dates associated with a second item in a text string of a fourth data set created with the second rule. A release date for the second item can then be determined by aggregating the future dates associated with the second item and selecting the release date that appears the most in the data sets. In some examples, a source of the release date, such as a newspaper periodical or an industry publication, can be weighted such that a release date provided in a data set (e.g., website) associated with the newspaper periodical/industry publication can be given more weight than other data sets (e.g., other web pages).

When a release date is predicted, third parties can create publications discussing when a product/work of art is expected to be released. The user can provide the datasets, i.e., webpages, identified during the process as evidence relating to why a third party believes that the product/work of art will be released on the published release date. Moreover, when a release date is predicted, a third party can prepare publications in anticipation of the product/work of art being available on the release date, such as frequently-asked-question (FAQ) publications, information describing the product/work or art, and the like.

In another aspect, the number of data sets discussing a product/work of art can be counted and used to predict a demand. Here, historical data can be accessed where a correlation between a number of data sets discussing the product/work of art of a previous release date and demand at the release date can be used to determine a demand for a product/work of art on a predicted release date. More specifically, a correlation between historical numbers of data sets discussing a release date for a product/work of art and a demand for the product/work of art at the release date can be used to predict a demand of a product/work of art at the future release date based on a current number of datasets discussing a future release for the product/work of art.

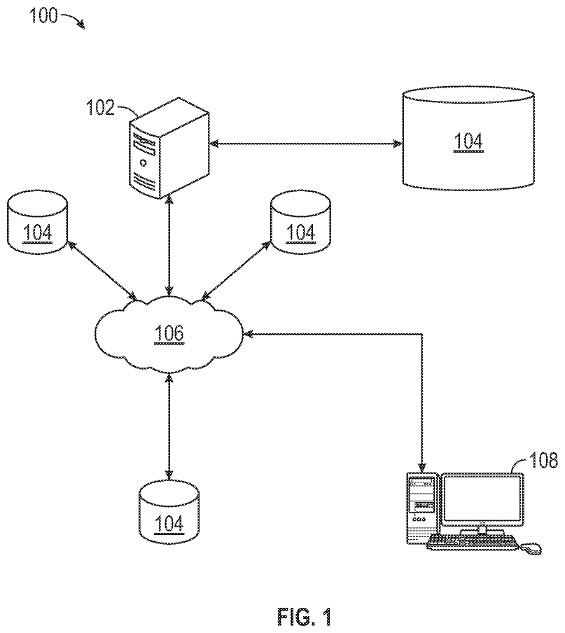

FIG. 1 is a network diagram illustrating a network environment 100 suitable for determining a release date for a product/work of art. The environment 100 can include an item release platform 102 communicatively coupled with databases 104 via a network 106. In addition, the environment 100 includes a computing device 108 in communication with the item release platform 102 and the databases 104 via the network 106. The item release platform 102 and the computing device 108 can be a general-purpose computer modified (e.g., configured or programmed) by software to be a special-purpose computer to perform the functions described herein for that machine, database, or device.

The databases 104 can be any organized collection of structured information or data that is stored in a computer system. The databases 104 can be controlled by a database management system and stored on a file system, computer clusters, or on cloud storage. The databases can store data sets, such as webpages, which can be test files written in Hypertext Markup Language (HTML). The datasets can describe the content of a web page and include references to other web resources. However, as used herein, data sets are not restricted to webpages.

The network 106 can be any network that enables communication between or among machines, databases (e.g., the databases 104), and devices (e.g., the item release platform 102). Accordingly, the network 106 can be a wired network, a wireless network (e.g., a mobile or cellular network), or any suitable combination thereof. The network 106 can include one or more portions that constitute a private network, a public network (e.g., the Internet), or any suitable combination thereof.

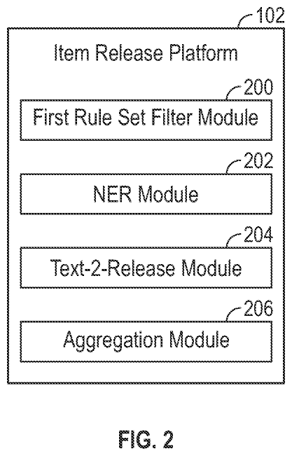

Now making reference to FIG. 2, a block diagram of the item release platform 102 that provides functionality to determine a release date for a product/work of art is shown. The item release platform 102 can include a first rule set filter module 200, a NER module 202, a neural network text-to-release module 204, and an aggregation module 206. All, or some, of the modules 200-206 of FIG. 2, communicate with each other, for example, via a network coupling, shared memory, and the like. Each module can be implemented as a single module, combined into other modules, or further subdivided into multiple modules. Other modules not pertinent to examples can also be included, but are not shown.

The first rule set filter module 200 can function to filter data sets using key phrases to create a first data set. The key phrases can intuitively have connections to future releases of products/works of art. While not exhaustive, examples of key phrases that can be used to identify webpages that can discuss product releases are listed in Table I below. Further examples of key phrases can be a date. More specifically, the date can relate to a future date. Thus, if the current date is Feb. 15, 2022, and the key phrase is “a future date,” the future date would be any date after Feb. 15, 2022.

TABLE I

“will be released”
“release date”
“to be released”
“will release”
“product launch”
“scheduled for release”
“will launch in”
“expected to launch”
“to come out in”
“release scheduled for”
“scheduled to be released”
“is expected to come out on”
“could arrive”
“will launch on”

The NER module 202 can function to detect possible names associated with products/works of art and any dates, such as release dates, that correspond to the names. The NER module 202 can include a NER model trained on a data set to detect product names and dates, such as a OntoNotes data set. With the trained NER model, the NER module 202 can identify product/work of art names based on the context of the text in a data set, such as text string in a web page. The NER model can be a second rule set that is applied to the first data set created by the first rule set filter module 200. Using the NER model, the NER module 202 can detect names of products/works of art and dates in the first data set to create a second data set. Moreover, the NER model can be trained to detect that text in data strings of a data set do not correlate to a product/work of art.

The text-2-release module 204 can implement a trained classifier that makes a connection between a first data point and a second data point within the second data set. The text-2-release module can implement a text-2-release model that can classify text that includes a future product release date within a data set, such as a web page. The text-2-release model can use a global attention mechanism guided by the output from the NER model. In particular, the text-2-release model can classify whether or not text within the data set, such as the second data set, includes a future product release. Moreover, the text-2-release module, via the text-2-release model, can output products/works of art and release dates associated with the products/works of art. The aggregation module 206 can function to aggregate products/works of art and the release dates associated with the products/works of art. In examples, the aggregated products/works of art and associated release dates can be used to predict release dates for the products/works of art based on which release date associated with a product/work of art appears the most.

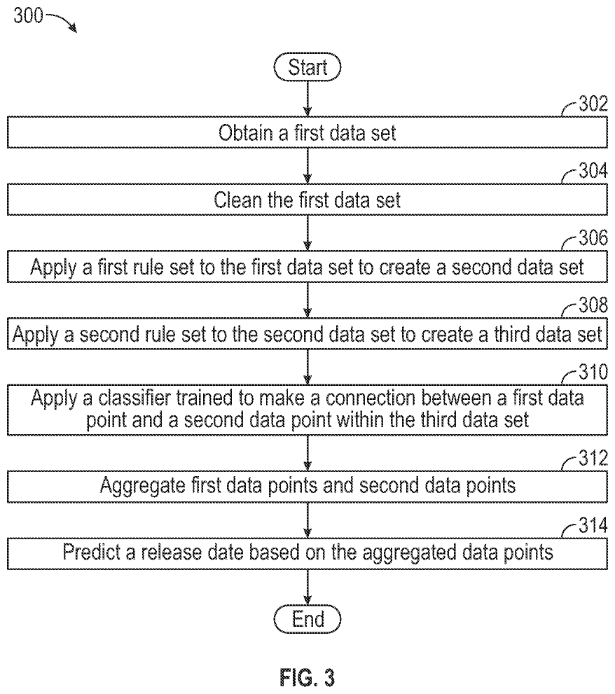

Now making reference to FIG. 3, a method 300 is shown that predicts a release date for a product/work of art. In this description, a neural network model can perform the method 300 where the neural network model can be implemented by the item release platform 102 and the modules 200-206. During an operation 302, the neural network model obtains first data sets. The first data sets can correspond to web pages pulled from various local and remote sources, such as the databases 104. In addition, thousands of data sets, i.e., thousands of web pages, can be obtained during the operation 302. The data sets can include text strings relating to products/works of art. The text strings in the data sets can include discussions relating to products/works of art, such as an upcoming release of a product/work of art, upcoming version releases of a product/work of art, and the like. The thousands of data sets can correspond to raw data gathered from the databases 104.

After obtaining the first data sets, the neural network model performs an operation 304, where the first data sets are cleaned. Any type of package which can be used to remove non-natural language texts such as error messages, source code, duplicate text, offensive language, or the like, can be used. Examples of packages can include a language detection library such as langdetect available from Google.™ During the operation 304, the raw data can be filtered during cleaning using the package to remove non-natural language texts. After the first data set is cleaned, the method 300 performs an operation 306.

During the operation 306, a first rule set is applied to the first data set in order to create a second data set with the first rule set filter module 200. The first rule set can include key phrases as in Table I where the item release platform 102 filters the first data set with the key phrases to create the second data set. The key phrases can have connections to future releases of products/works of art to identify websites obtained during the operation 302 that can discuss product releases. To further illustrate, a web page can include text strings having the phrase “will be released.” Here, the phrase “will be released” intuitively has a connection to the future of release of an item, a person, an entity, or the like.

While examples relate to determining a future release date for an item, during the operation 306, in some examples, the first rule set is applied using the key phrases above without regard to what the key phrase relates to. Thus, while web sites in the first data can include one, some, or all of the key phrases in Table I, the key phrases can relate to anything. To further illustrate, the key phrases could relate to concert tickets, i.e., tickets to the rock band Pearl Jam™ “will be released” for sale on Mar. 31, 2022, a television show, i.e., Grey's Anatomy™ is “to come out in” September of 2022, or the like. Regardless, during the operation 306, the item release platform 102 can filter the web pages relating to Pearl Jam™ and Grey's Anatomy™ from the first data set to create a second data set during the operation 306 that include these web pages.

After the operation 306, an operation 308 is performed, where the method 300 can use the NER module 202 that implements a deep learning model or a neural network to identify and/or extract a product/work of art name and release date in the second data set to create a third data set. As used herein, a work of art can refer to a video game, a book, a movie, and art. The deep learning model can be an open source model that can identify and/or extract a name of a product/work of art from text strings in the second data set. In addition, the deep learning model can be used to identify and/or extract dates from the text strings in the second data set. Thus, during the operation 308, the deep learning model can identify a product/work of art name and a release date within text strings of the second data set.

Once the method 300 creates the third data set in the operation 308, the method 300 performs an operation 310, where a trained classifier implemented at the text-2-release module 204 makes a connection between a first data point and a second data point within the third data set. The classifier can be a deep learning model. The first data point can correspond to a product/work of art while the second data point can correspond to a release date. Thus, during the operation 310, the classifier can make a connection between the product/work of art and the release date in text strings of the third data set to determine if the text string relates to an actual release date of the product/work of art or if the release date relates to something other than a release date of the product/work of art. In some examples, when the first data point corresponds to a product/work of art, the item release platform 102 can count the number of data sets that reference the first data point. To further illustrate, the first data point could be a video game where the data sets are web pages mentioning the video game and the item release platform 102 can count the number of web pages that mention the video game.

The classifier can implement a transformer architecture of a self-attention mechanism where the classifier is trained to learn a connection between a word in a sentence with other words in a webpage. The classifier can be trained with training data corresponding to data sets that include information pertaining to product/work of art releases and information that does not pertain to product/work of art releases. These data sets are provided to the classifier, which can also implement a neural network in order to train the classifier to distinguish between information pertaining to product/work of art releases and information that does not pertain product/work of art releases. For example, the text string “concert tickets for Band X playing in Raleigh, NC are expected to be released on Jan. 2, 2023” in a data set could be used as training data for the classifier, where the product is concert tickets for a concert by Band X and the release date is Jan. 2, 2023. The classifier can learn a connection between the term “concert tickets,” which would be a product, the phrase “are expected to be released on,” and “Jan. 2, 2023,” which would be a release date and determine that concert tickets will be released on Jan. 2, 2023.

Moreover, the text string “Tony Josephson will be released from prison on Jan. 2, 2023” could also be used as training data for the classifier. However, the classifier can learn that when a text string includes a person along with the term “prison,” this does not relate to a product/work of art release date and should be discarded during a filtering process, i.e. this relates to something other than a release date of a product/work of art. Furthermore, the third data set can include information such as when a review for a product/work of art will be released, when a particular vendor will also start selling a product/work of art in the future that is already for sale, or the third data set can include information about a previous release of a product. Similar language can include “has a release date” where the classifier can be trained to recognize that this type of language refers to a past release and not a future release. This can be supplied as training data to the classifier to train the classifier to discard this type of data during a filtering process. Again, this can relate to something other than a release date of a product. As such, during the operation 310, on Mar. 31, 2022, the classifier may see the text string “concert tickets for the concert by Pearl Jam™ went on sale on Feb. 3, 2022.” The classifier will be able to determine that Feb. 3, 2022 is a previous release date and will discard this text string during the operation 310.

As noted above, during the operation 308, the deep learning model identifies products/work of arts and release dates in text strings of the second data set. The second data set can comprise thousands of web pages. During the operation 310, since the classifier is determining a connection between a first data point, such as the product, and a second data point, such as the release date, the classifier can quickly process the thousands of web pages as a result of focusing on the products/work of arts and the release dates in the text strings of the web pages.

During the operation 310, the method 300 can predict which data sets have a future release date. Initially, the release dates in the data sets are handled. Handling can include recognizing text strings based on language patterns that have been used to train a neural network model. Examples of patterns are shown below in Table II where the neural network model can recognize text string language patterns in data sets such as webpages that correspond to the patterns in Table II.

TABLE II

“the [first/second] half of YEAR”
“the [first/last] month of YEAR”
“the [beginning/end] of YEAR”
“[early/late] YEAR”
“the [first/second/third/forth/last] quarter of YEAR”
“[q1/q2/q3/q4] YEAR”
“MONTH [next/this] year”
“the [beginning/end] of MONTH”
“[this/next] SEASON”
“the SEASON of [this/next] year”
“the SEASON of YEAR”

In examples, a recognized language pattern can be mapped to a particular structure to provide a release date. To further illustrate, if the neural network model finds the phrase “the first month of 2023,” the neural network model can map this pattern to the structure of the first month of the year where January has thirty-one days. As such, the neural network model will note that the release date can be between Jan. 1, 2023 and Jan. 31, 2023. Furthermore, the neural network model can find the phrase Christmas (which can correspond to SEASON in Table II) of 2022. The neural network model can map this pattern to the structure of the Christmas season, which would be between Nov. 25, 2022 and Jan. 1, 2023. Accordingly, the neural network model will note that the release date can be between Nov. 25, 2022 and Jan. 1, 2023. In examples, the dates corresponding to the ranges can be pre-loaded onto the item release platform 102 such that mapping can occur.

After the operation 310, the neural network model performs an operation 312 where the first and second data points are aggregated. During the operation 312, in examples where the first data point corresponds to a product/work of art and the second data point relates to a release date, the neural network model can aggregate the number of times a product was mentioned in the data sets and the number of times different release dates were associated with the product/work of art when the product/work of art was mentioned in the data sets. During aggregation, the neural network model can tally the number of times different release dates were mentioned in association with the product/work of art. In particular, the neural network model can tally up all of the potential release dates and count the number of times each of the potential release dates have been mentioned in the data sets.

Using the aggregated first and second data points, the neural network model can predict a release date during an operation 314. The neural network model can determine which date of the aggregated release dates appears the most often during the operation 314. Once the release date is predicted in the operation 314, the method 300 is complete.

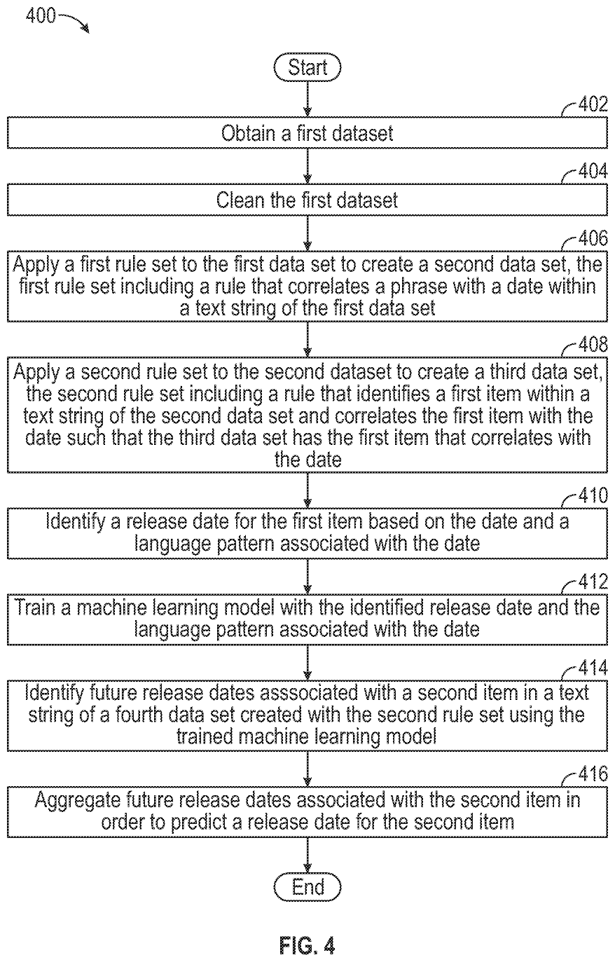

As a further example of a method of predicting a release date for a product/work of art, reference is now made to FIG. 4 and a method 400. Initially, similar to the operation 302, an operation 402 is performed where a first data set is obtained. Once the first data set is obtained, similar to the operation 304, the first data set is cleaned during an operation 404. After the first data set is cleaned, the method 400 performs an operation 406.

During the operation 406, a first rule set is applied to the first data set in order to create a second data set with the first rule set filter module 200 similar to the operation 306. However, in addition to what was described above with reference to the operation 306, during the operation 406, the method 400 applies a rule from the first rule set that correlates a phrase with a date within a text string of a first data set using key phrases as discussed above with respect to the operation 306. In particular, the rule from the first rule set can filter the first data set using phrases listed in Table I in addition to other phrases that may relate to when a product/work of art will be released.

As an example of the method 400 and referred to herein as “the first example,” assume the current date is Aug. 15, 2022 where, during the operations 302 and 304, the first datasets (A)-(D) are created as follows:
(A) “Pearl Jam™ is playing in Raleigh, NC, concert tickets, that had a release date of Jan. 2, 2022, are currently available”
(B) “Tony Josephson is scheduled to be released from prison on Jan. 2, 2023”
(C) “Hungarian Rhapsody: The Eastern Front in Hungary, is expected to come out in the last month of 2022.”
(D) “The Samsung™ Galaxy Note 20 is the upcoming flagship from Samsung™ and is scheduled for release on Jan. 2, 2023”
(E) “Our sources have not been able to determine when the 2024 Mercedes-Benz™ E450 will launch.”

In the first example, during the operation 406, the first rule set filter module 200 applies a rule to the first data sets (A)-(D) that correlates a phrase with a date within a text string of a first data set using key phrases. For the first data set (A), the first rule set filter module 200 correlates the phrase “a release date” from Table I to the date “Jan. 2, 2022.” For the first data set (B), the first rule set filter module 200 correlates the phrase “scheduled to be released” to the date “Jan. 2, 2023.” For the first data set (C), the first rule set filter module 200 correlates the phrase “is expected to come out on” to the date “in the last month of 2022.” For the first data set (D), the first rule set filter module 200 correlates the phrase “is scheduled for release” to the date “Jan. 2, 2023.” For the first data set (E), while this data set includes the phrase “will launch,” the first data set (E) does not include a date. Thus, the first rule set filter module 200 filters out the first data set (E). In the first example, since the first rule set filter module 200 was able to correlate phrases to dates in all of the first data sets (A)-(D), the second data includes the data sets (A)-(D) such that the data sets (A)-(D) become the second data set in the first example.

Returning attention to FIG. 4 and the method 400, upon completion of the operation 406, an operation 408 is performed, where a second rule set is applied to the second data set similar to the operation 308. However, in addition to the description above with reference to the operation 308, during the operation 408, a rule from the second rule set identifies a first item within a text string of the second data set. Furthermore, a rule from the second rule set correlates the first item with the date previously correlated with the phrase (operation 406) during the operation 408. In examples, the first item can be a product/work of art where the date correlated with the phrase can be correlated with the product/work of art.

Returning to the first example, as noted above, the second data set includes the data sets (A)-(D). During the operation 408, the second rule set identifies “concert tickets” as a product/work of art within the text string “Pearl Jam™ is playing in Raleigh, NC, concert tickets, that had a release date of Jan. 2, 2022, are currently available.” Furthermore, the second rule set correlates “concert tickets” with the date “Jan. 2, 2022” during the operation 408. In the example, during the operation 408, the second rule set identifies “prison” within the text string “Tony Josephson is scheduled to be released from prison on Jan. 2, 2023.” However, as noted above, the NER model, which can be used as the second rule set, can be trained to filter text strings and data sets that do not include a product/work of art. Here, the second rule set determines that “prison” is not a product/work of art based on being trained. Thus, during the operation 408, the data set (B) is filtered out.

Still sticking with the first example, during the operation 408, the second rule set identifies “Hungarian Rhapsody: The Eastern Front in Hungary” as a product/work of art within the text string “Hungarian Rhapsody: The Eastern Front in Hungary, is expected to come out in the last month of 2022.” The second rule set also correlates “Hungarian Rhapsody: The Eastern Front in Hungary” with the date “in the last month of 2022” during the operation 408. During the operation 408, in the example, the second rule set identifies “Samsung™ Galaxy Note 20” as a product/work of art within the text string “The Samsung™ Galaxy Note 20 is the upcoming flagship from Samsung™ and is scheduled for release on Jan. 2, 2023.” The second rule set also correlates “Samsung™ Galaxy Note 20” with the date “Jan. 2, 2023” during the operation 408.

As noted above, the second rule set is used to create a third data set. In the first example, since the second data set (B) did not include a product/work of art, i.e., it related to Tony Josephson being released from prison, the second data set (B) is filtered out such that the third data set includes the third data sets (A), (C), and (D).

Upon completion of the operation 408, the method 400 performs an operation 410, where a release date for the first item is identified based on the date and a language pattern associated with the date. Similar to the operation 310, text strings are recognized based on language patterns that the text-2-release module 204 has trained with, such as the language patterns shown in Table II above and then mapped to a particular structure. The operation 410 can be repeated over time.

Returning to the first example, during the operation 410, the text-2-release module 204 identifies a release date using language patterns in the data sets (A), (C), and (D) of the third data set. In particular, the text-2-release module recognizes that the language pattern “concert tickets” “that had a release date of Jan. 2, 2022” as a language pattern relating to an event that occurred in the past for the data set (A). Specifically, as noted above, the neural network model used by the text-2-release module is trained to identify that the language pattern “had a release date” refers to a past activity such that when the neural network model of the text-2-release module 204 finds this language pattern, the neural network model recognizes that the date accompanying this language pattern does not pertain to a future release date. In the first example, the text-2-release module 204 can discard the data set (A) since the data set (A) does not include a future release date of an item.

Still sticking with the first example, the text-2-release module 204 recognizes the language pattern “Hungarian Rhapsody: The Eastern Front in Hungary” “is expected to come out” as a language pattern relating to a future release date based on being trained to recognize this language pattern for the data set (C). Furthermore, during the operation 410, the text-2-release module 204 recognizes that the phrase “is expected to come out in” refers to the date “the last month in 2022.” Here, using the Table II, the text-2-release module 204 matches the term “the last month in 2022” to December of 2022 during the operation 410. In the first example, after matching, the text-2-release module 204 uses the dates corresponding to the ranges pre-loaded onto the item release platform 102 to determine the release date of “Hungarian Rhapsody: The Eastern Front in Hungary” as being between Dec. 1, 2022 and Dec. 31, 2022.

In addition, the text-2-release module 204 recognizes the language pattern “is scheduled for release” in the third data set (D) as a language pattern relating to a future release date based on being trained to recognize this language pattern. During the operation 410, the text-2-release module 204 also recognizes that the phrase “is scheduled for release” refers to the date “Jan. 2, 2023.” As such, the text-2-release module 204 identifies the release date of the Samsung™ Galaxy Note 20 as Jan. 2, 2023.

After completion of the operation 410, the method 400 performs an operation 412, where a machine learning model, such as the neural network model, is trained with the identified release date and the language pattern associated with the date. During the operation 412, the release dates and the language patterns identified during the operation 410 are provided to the neural network model as training data to further refine the neural network model over time. In particular, the neural network model can continually be provided training data in the form of identified release dates and language patterns over time such that the neural network model can be refined over time. As noted above, the operation 410 can be repeated overtime. In examples where the operation 410 is repeated overtime, the operation 412 can also be repeated over time based on repeating the operation 410.

Returning to the first example, during the operation 412, the identified release date between Dec. 1, 2022 and Dec. 31, 2022 along with the language pattern “is expected to come out” is provided as training data to the neural network model. Moreover, the identified release date of Jan. 2, 2023 along with the language pattern of “is scheduled for release” is provided as training data to the neural network model during the operation 412.

Once the identified release dates and language patterns are provided as training data in the operation 412, the method 400 performs an operation 414, where future release dates associated with a second item in a text string of a fourth data set created with the second rule set using the trained machine learning model is identified. Here, the fourth data set is created in accordance with the operations 402-408 as discussed above.

As an example of the operation 414 and referred to herein as the “second example,” during the operation 414, a fourth data set having data sets (F)-(I) as shown below is obtained using the principles described above with reference to the operations 402-412. In this second example, the fourth data set can include thousands of data sets. However, for ease of discussion, only the data sets (F)-(I) of the fourth data set will be discussed with reference to FIG. 4 and the method 400.
(F) “Speaking on condition of anonymity, a high ranking source at Take-Two Interactive Software, Inc.™ believes that NBA™ 2k24 will be released at the end of the third quarter of 2022.”
(G) “Based on past product launches from Take-Two Interactive Software, Inc.™, we believe that NBA™ 2k24 will launch on Sep. 15, 2022.”
(H) “The general consensus is that Nikola Jokic will be the cover athlete for NBA™ 2k24, which is expected to launch on Sep. 15, 2022.”
(I) “Due to labor shortages, NBA™ 2k24 is expected to come out on Nov. 15, 2022.”

In the second example, the second item can correspond to the product/work of art NBA™ 2k24. Here, the fourth data set (F) indicates that “NBA™ 2k24 will be released at the end of the third quarter of 2022.” The text-2-release module 204, which can employ the trained neural network model, can identify a date range between Sep. 1, 2022 to Sep. 30, 2022 as the release date based on the date “the end of the third quarter of 2022” and the language pattern “will be released” associated with this release date using the principles described above. Additionally, the text-2-release module can map the end of the third quarter of 2022 to September of 2022 and can map a release date of between Sep. 1, 2022 and Sep. 30, 2022 using the principles described above.

Moreover, the fourth data set (G) states that “we believe that NBA™ 2k24 will launch on Sep. 15, 2022.” The text-2-release module 204, which can employ the trained neural network model, can identify a release date of Sep. 15, 2022 based on the date Sep. 15, 2022 that is associated with the language pattern “will launch on.” In the second example, the fourth data set (H) indicates that NBA™ 2k24 “is expected to launch on Sep. 15, 2022.” Again, the text-2-release module 204, which can employ the trained neural network model, can identify a release date of Sep. 15, 2022 based on the date Sep. 15, 2022 that is associated with the language pattern “expected to launch.”

Staying with the second example, the fourth data set (I) indicates that “NBA™ 2k24 is expected to come out on Nov. 15, 2022.” Thus, the text-2-release module 204 can identify a release date of Nov. 15, 2022 based on the date Nov. 15, 2022 that is associated with the language pattern “is expected to come out on.”

Returning to the method 400, after future release dates are identified during the operation 414, the trained neural network model aggregates the future release dates associated with the second item in order to determine/predict a release date for the second item during an operation 416. In examples, future release dates are aggregated and then a release date is predicted in a manner similar to that discussed above with reference to the operations 312 and 314. In particular, the release date that occurs the most is used as the predicted release date.

Returning to the second example, during the operation 416, as noted above, the identified released dates were between Sep. 1, 2022 and Sep. 30, 2022, Sep. 15, 2022, and Nov. 15, 2022. During the operation 416, the text-2-release module 204 can aggregate these dates and determine which date is the most common date by virtue of the date appearing the most. In examples, the common date can be determined as being the release date such that the most common date will be used as the predicted release date. In the second example, the future release date of Sep. 15, 2022 appeared twice while the date range of Sep. 1, 2022 to Sep. 30, 2022 and the date Nov. 15, 2022 appeared once. Therefore, in the second example, Sep. 15, 2022 is predicted as the release date for the product/work of art NBA™ 2k24. Upon completion of the operation 416, the method 400 is complete.

The predicted release date for a product/work of art can be used for various purposes to determine demand for the product/work of art at the time of release. More specifically, historical demand data for a product/work of art at the time of previous releases can be used to predict demand at the predicted release date. Furthermore, the previous releases of the product/work of art can have a characteristic or attribute that is similar to, or the same as, a characteristic or attribute for a future product/work of art. Demand can relate to inquiries regarding the purchase of the product/work of art, general information about the product/work of art, availability regarding the product/work of art, purchase requests, and the like.

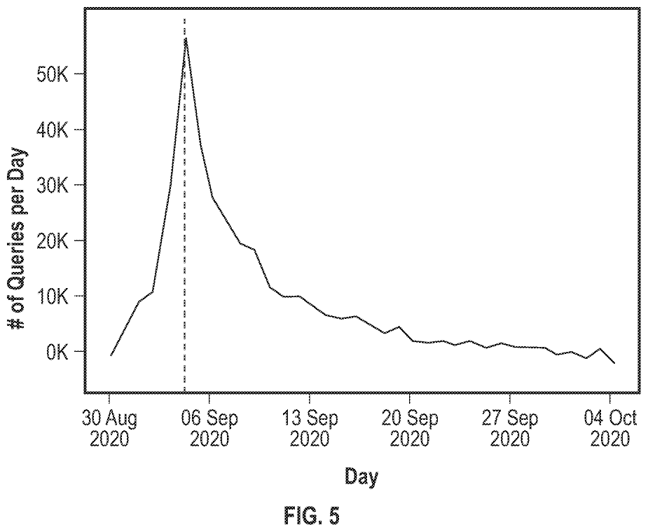

A correlation can be determined between the number of times a product/work of art was mentioned in data sets, such as web pages, and the number of queries at the release date. For example, making reference to FIG. 5, a graphic is shown that correlates a release date of a product/work of art to a number of queries. Here, a product/work of art NBA™ 2k21 was released on Sep. 6, 2020, as shown at A. As can be seen with reference to FIG. 5, on Sep. 6, 2020, approximately 55,000 queries were made for the product/work of art NBA™ 2k21. In addition, while not shown, a determination was made that 5,500 web pages were found that referenced the product/work of art NBA™ 2k21. Therefore, using historical data, a correlation can be made that for every web page that mentions a work of art, 10 (55000/5500) queries will be made regarding that product/work of art on the release date of the product/work of art.

Returning to the second example and the second item NBA™ 2k24, as noted above, while only the data sets (F)-(I) were discussed with reference to FIG. 4 and the method 400, the fourth data set can include thousands of data sets. In the example, the fourth data set included 10,000 web pages. In FIG. 5, a determination was made that for every web page that discussed the product/work of art NBA™ 2k21, there were 10 queries. Here, since the fourth data set included 10,000 web pages, a determination can be made that there will be 100,000 queries made regarding the product/work of art NBA™ 2k24 on the release date of Sep. 15, 2022.

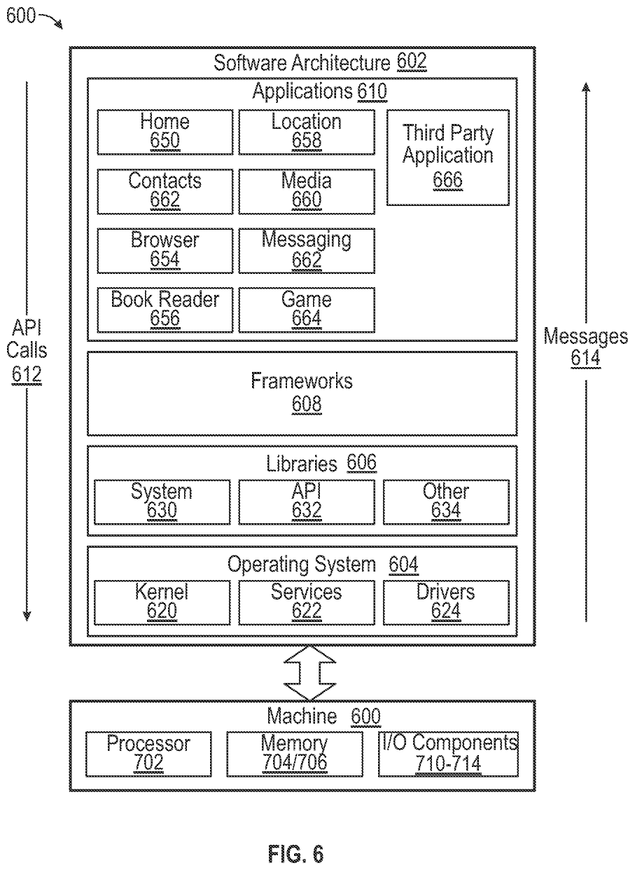

FIG. 5 is a block diagram 600 illustrating a software architecture 602, which may be installed on any one or more of the devices described above. FIG. 6 is merely a non-limiting example of a software architecture, and it will be appreciated that many other architectures may be implemented to facilitate the functionality described herein. The software architecture 602 may be implemented by hardware such as a machine 600 of FIG. 6 that includes a processor 602, memory 604 and 606, and I/O components 710-714. In this example, the software architecture 602 may be conceptualized as a stack of layers where each layer may provide a particular functionality. For example, the software architecture 602 includes layers such as an operating system 604, libraries 606, frameworks 608, and applications 610. Operationally, the applications 610 invoke application programming interface (API) calls 612 through the software stack and receive messages 614 in response to the API calls 612, according to some implementations.

In various implementations, the operating system 604 manages hardware resources and provides common services. The operating system 604 includes, for example, a kernel 620, services 622, and drivers 624. The kernel 620 acts as an abstraction layer between the hardware and the other software layers in some implementations. For example, the kernel 620 provides memory management, processor management (e.g., scheduling), component management, networking, and security settings, among other functionality. The services 622 may provide other common services for the other software layers. The drivers 624 may be responsible for controlling or interfacing with the underlying hardware. For instance, the drivers 624 may include display drivers, camera drivers, Bluetooth*-drivers, flash memory drivers, serial communication drivers (e.g., Universal Serial Bus (USB) drivers), Wi-Fi® drivers, audio drivers, power management drivers, and so forth.

In some implementations, the libraries 606 provide a low-level common infrastructure that may be utilized by the applications 610. The libraries 606 may include system libraries 630 (e.g., C standard library) that may provide functions such as memory allocation functions, string manipulation functions, mathematic functions, and the like. In addition, the libraries 606 may include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 may also include a wide variety of other libraries 634 to provide many other APIs to the applications 610.

The frameworks 608 provide a high-level common infrastructure that may be utilized by the applications 610, according to some implementations. For example, the frameworks 608 provide various graphic user interface (GUI) functions, high-level resource management, high-level location services, and so forth. The frameworks 608 may provide a broad spectrum of other APIs that may be utilized by the applications 610, some of which may be specific to a particular operating system or platform.

In an example, the applications 610 include a home application 650, a contacts application 652, a browser application 654, a book reader application 656, a location application 658, a media application 660, a messaging application 662, a game application 664, and a broad assortment of other applications such as a third-party application 666. According to some examples, the applications 610 are programs that execute functions defined in the programs. Various programming languages may be employed to create one or more of the applications 610, structured in a variety of manners, such as object-orientated programming languages (e.g., Objective-C, Java, or C++) or procedural programming languages (e.g., C or assembly language). In a specific example, the third-party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 666 may invoke the API calls 612 provided by the mobile operating system (e.g., the operating system 604) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 106 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 6 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 610 (e.g., a liquid crystal display (LCD) or a cathode ray tube (CRT)). The computer system 700 also includes an alphanumeric input device 712 (e.g., a keyboard), a user interface (UI) navigation device (cursor control device) 614 (e.g., a mouse), a disk drive unit 716, a signal generation device 718 (e.g., a speaker) and a network interface device 720.

The drive unit 716 includes a machine-readable medium 722 on which is stored one or more sets of instructions and data structures (e.g., software) 624 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. Instructions 724 may also reside within the static memory 706.

While the machine-readable medium 722 is shown in an example to be a single medium, the term “machine-readable medium” may include a single medium or multiple media (e.g., a centralized or distributed database, and/or associated caches and servers) that store the one or more instructions or data instructions 724. The term “machine-readable medium” shall also be taken to include any tangible medium that is capable of storing, encoding or carrying instructions 724 for execution by the machine and that cause the machine to perform any one or more of the methodologies of the present invention, or that is capable of storing, encoding or carrying data structures utilized by or associated with such instructions 724. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 724 for execution by the machine, and includes digital or analog communications signals or other intangible media to facilitate communication of such software.

In various example examples, one or more portions of the network 726 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 726 or a portion of the network 726 may include a wireless or cellular network, and the coupling 682 may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method, comprising:
applying a first rule set to a first data set to create a second data set, the first rule set including a rule that correlates a phrase with a date within a text string of the first data set;
applying a second rule set to the second data set to create a third data set, the second rule set including a rule that:
identifies a first item within a text string of the second data set; and
correlates the first item with the date such that the third data set has the first item that correlates with the date;
identifying a release date for the first item based on the date and a language pattern associated with the date;
training a machine learning model with the identified release date and the language pattern associated with the date;
using the trained machine learning model, identifying future dates associated with a second item in a text string of a fourth data set created with the second rule set; and
aggregating the future dates associated with the second item in order to determine a release date for the second item.

2. The method of claim 1, further comprising refining the machine learning model over time by:
repeating the operation of identifying the release date for the first item based on the date and the language pattern associated with the date over time; and
repeating the operation of training the machine learning model with the identified release date and the language pattern associated with the date over time.

3. The method of claim 1, wherein aggregating the dates associated with the second item includes:
determining a number of instances each future date of the future dates appears in the text string of the fourth data set;
ranking each future date of the future dates associated with the second item based on the number of instances; and
selecting a highest ranking date of the ranked dates as the release date.

4. The method of claim 1, wherein aggregating the future dates associated with the second item includes mapping language patterns having the dates associated with the second item to a third rule set to determine the release date for the second item.

5. The method of claim 1, the second item having a first attribute and the method further comprising:
identifying a third item having the first attribute;
accessing historical release data associated with the third item;
accessing demand information associated with the historical release data; and
determining a demand associated with the second date at the release date based on the demand information.

6. The method of claim 1, wherein the first data set includes raw data gathered from remote sources and filtered with a third ruleset where the raw data is filtered with the third ruleset to create the first data set.

7. The method of claim 1, wherein the second rule set employs a deep learning model.

8. A non-transitory machine-readable medium having instructions embodied thereon, the instructions executable by a processor of a machine to perform operations comprising:
applying a first rule set to a first data set to create a second data set, the first rule set including a rule that correlates a phrase with a date within a text string of the first data set;
applying a second rule set to the second data set to create a third data set, the second rule set including a rule that:
identifies a first item within a text string of the second data set; and
correlates the first item with the date such that the third data set has the first item that correlates with the date;
identifying a release date for the first item based on the date and a language pattern associated with the date;
training a machine learning model with the identified release date and the language pattern associated with the date;
using the trained machine learning model, identifying future dates associated with a second item in a text string of a fourth data set created with the second rule set; and
aggregating the future dates associated with the second item in order to determine a release date for the second item.

9. The non-transitory machine-readable medium of claim 8, the operations further comprising refining the machine learning model over time by:
repeating the operation of identifying the release date for the first item based on the date and the language pattern associated with the date over time; and
repeating the operation of training the machine learning model with the identified release date and the language pattern associated with the date over time.

10. The non-transitory machine-readable medium of claim 8, wherein, when aggregating the dates associated with the second item the operations further comprise:
determining a number of instances each future date of the future dates appears in the text string of the fourth data set;
ranking each future date of the future dates associated with the second item based on the number of instances; and
selecting a highest ranking date of the ranked dates as the release date.

11. The non-transitory machine-readable medium of claim 8, wherein aggregating the future dates associated with the second item includes mapping language patterns having the dates associated with the second item to a third rule set to determine the release date for the second item.

12. The non-transitory machine-readable medium of claim 8, wherein the second item has a first attribute and the operations further comprise:
identifying a third item having the first attribute;
accessing historical release data associated with the third item;
accessing demand information associated with the historical release data; and
determining a demand associated with the second date at the release date based on the demand information.

13. The non-transitory machine-readable medium of claim 8, wherein the first data set includes raw data gathered from remote sources and filtered with a third ruleset where the raw data is filtered with the third ruleset to create the first data set.

14. The non-transitory machine-readable medium of claim 8, wherein the second rule set employs a deep learning model.

15. A device, comprising:
a processor; and
memory including instructions that, when executed by the processor, cause the device to perform operations including:
applying a first rule set to a first data set to create a second data set, the first rule set including a rule that correlates a phrase with a date within a text string of the first data set;
applying a second rule set to the second data set to create a third data set, the second rule set including a rule that:
identifies a first item within a text string of the second data set; and
correlates the first item with the date such that the third data set has the first item that correlates with the date;
identifying a release date for the first item based on the date and a language pattern associated with the date;
training a machine learning model with the identified release date and the language pattern associated with the date;
using the trained machine learning model, identifying future dates associated with a second item in a text string of a fourth data set created with the second rule set; and
aggregating the future dates associated with the second item in order to determine a release date for the second item.

16. The device of claim 15, the operations further comprising refining the machine learning model over time by:
repeating the operation of identifying the release date for the first item based on the date and the language pattern associated with the date over time; and
repeating the operation of training the machine learning model with the identified release date and the language pattern associated with the date over time.

17. The device of claim 15, wherein, when aggregating the dates associated with the second item the operations further comprise:
determining a number of instances each future date of the future dates appears in the text string of the fourth data set;
ranking each future date of the future dates associated with the second item based on the number of instances; and
selecting a highest ranking date of the ranked dates as the release date.

18. The device of claim 15, wherein aggregating the future dates associated with the second item includes mapping language patterns having the dates associated with the second item to a third rule set to determine the release date for the second item.

19. The device of claim 15, wherein the second item has a first attribute and the operations further comprise:
identifying a third item having the first attribute;
accessing historical release data associated with the third item;
accessing demand information associated with the historical release data; and
determining a demand associated with the second date at the release date based on the demand information.

20. The device of claim 15, wherein the first data set includes raw data gathered from remote sources and filtered with a third ruleset where the raw data is filtered with the third ruleset to create the first data set.
